(19) United States
(12) Patent Application Publication
(10) Pub. No.: US 2025/0218135 A1
(43) Pub. Date: Jul. 3, 2025

(54) METHOD FOR SCENARIO PROCESSING, TERMINAL DEVICE AND STORAGE MEDIUM

(71) Applicant: Beijing Zitiao Network Technology Co., Ltd., Beijing (CN)

(72) Inventor: Dikai FAN, Beijing (CN)

(21) Appl. No.: 18/988,520

(22) Filed: Dec. 19, 2024

(30) Foreign Application Priority Data
Dec. 29, 2023 (CN) 202311869530.5

(51) Int. Cl. G06T 19/00; G06T 19/20

(52) U.S. Cl. CPC G06T 19/006; G06T 19/20; G06T 2219/2016

(57) ABSTRACT

A method for scenario processing, a terminal device and a storage medium are provided. The method includes: acquiring information of a first point cloud corresponding to a target scenario collected by a terminal device; acquiring information of a second point cloud corresponding to the target scenario collected by a target device; determining a target point cloud, corresponding to the second point cloud, in the first point cloud based on the information of the first point cloud and the information of the second point cloud; and determining a scale for constructing the target scenario based on the target point cloud and the second point cloud.

### CROSS-REFERENCE TO RELATED APPLICATION

This application claims the priority to and benefits of the Chinese Patent Application, No. 202311869530.5, which was filed on Dec. 29, 2023, and is hereby incorporated by reference in its entirety.

### TECHNICAL FIELD

Embodiments of the present disclosure relate to the technical field of scenario reconstruction and, in particular, to a method for scenario processing, a terminal device and a storage medium.

### BACKGROUND

Mixed Reality (MR) technology may introduce virtual scenario information in a real environment to enhance the sense of reality of user experience.

At present, during scenario reconstruction, an MR device may collect environmental information in a real environment by means of a plurality of sensors, and perform scenario reconstruction according to the environmental information in the real environment. However, when a plurality of MR devices are connected, the sensors of each MR device produce calibration errors, resulting in a large error between the scenarios reconstructed by the plurality of MR devices.

### SUMMARY

Embodiments of the present disclosure provide a method and an apparatus for scene processing, a terminal device and a storage medium.

At least one embodiment of the present disclosure provides a method for scene processing, which includes:
acquiring information of a first point cloud corresponding to a target scenario collected by a terminal device;
acquiring information of a second point cloud corresponding to the target scenario collected by a target device;
determining a target point cloud, corresponding to the second point cloud, in the first point cloud based on the information of the first point cloud and the information of the second point cloud; and
determining a scale for constructing the target scenario based on the target point cloud and the second point cloud.

At least one embodiment of the present disclosure provides an apparatus for scene processing, which includes a first acquisition module, a second acquisition module, a first determination module, and a second determination module, where
the first acquisition module is configured to acquire information of a first point cloud corresponding to a target scenario collected by a terminal device;
the second acquisition module is configured to acquire information of a second point cloud corresponding to the target scenario collected by a target device;
the first determination module is configured to determine a target point cloud, corresponding to the second point cloud, in the first point cloud based on the information of the first point cloud and the information of the second point cloud; and
the second determination module is configured to determine a scale for constructing the target scenario based on the target point cloud and the second point cloud.

At least one embodiment of the present disclosure provides a terminal device processing, which includes at least one processor and at least one memory,
where the at least one memory stores computer-executable instructions; and
the at least one processor executes the computer-executable instructions stored in the at least one memory and is caused to execute the method for scenario processing provided by at least one of the above embodiments.

At least one embodiment of the present disclosure provides a non-transitory computer-readable storage medium, which stores computer-executable instructions, where a processor upon executing the computer-executable instructions, implements the method for scenario processing provided by at least one of the above embodiments.

### BRIEF DESCRIPTION OF DRAWINGS

To describe the technical solutions in the embodiments of the present disclosure more clearly, the drawings required in the description of the embodiments will be described briefly below. Apparently, other drawings can also be derived from these drawings by those ordinarily skilled in the art without creative efforts.

FIG. 1 is a schematic diagram of an application scenario according to an embodiment of the present disclosure;

FIG. 2 is a schematic flowchart of a method for scenario processing according to an embodiment of the present disclosure.

FIG. 3 is a schematic diagram of a first point cloud according to an embodiment of the present disclosure;

FIG. 4 is a schematic diagram of a second point cloud according to an embodiment of the present disclosure;

FIG. 5 is a schematic diagram of a first tetrahedron according to an embodiment of the present disclosure;

FIG. 6 is a schematic diagram of a first line segment and a second line segment according to an embodiment of the present disclosure;

FIG. 7 is a schematic diagram of determining a scale for constructing the target scenario according to an embodiment of the present disclosure;

FIG. 8 is a schematic diagram of a method for determining a target point cloud according to an embodiment of the present disclosure;

FIG. 9 is a schematic diagram of determining a target point cloud according to an embodiment of the present disclosure;

FIG. 10 is a process diagram of a method for scenario processing according to an embodiment of the present disclosure;

FIG. 11 is a schematic structural diagram of an apparatus for scenario processing according to an embodiment of the present disclosure; and

FIG. 12 is a schematic structural diagram of a terminal device according to an embodiment of the present disclosure.

### DETAILED DESCRIPTION

Exemplary embodiments will be described herein in detail, examples of which are represented in the drawings. When the following description relates to the drawings, the same numerals in the different drawings indicate the same or similar elements unless otherwise indicated. The embodiments described in the following exemplary embodiments do not represent all embodiments consistent with the present disclosure. Rather, they are only examples of apparatus and method consistent with some aspects of the present disclosure as detailed in the claims.

For ease of understanding, the following describes concepts involved in embodiments of the present disclosure.

Terminal device is a device with wireless transceiving functions. The terminal device may be deployed on land, including indoor or outdoor, handheld, wearable or vehicle mounted types. The terminal device may be a mobile phone, a pad, a computer with wireless transceiving functions, a virtual reality (VR) terminal device, an augmented reality (AR) terminal device, a wireless terminal in industrial control, a vehicle terminal device, a wireless terminal in self driving, a wireless terminal device in remote medical, a wireless terminal device in smart grid, a wireless terminal device in transportation safety, a wireless terminal device in smart city, a wireless terminal device in smart home, a wearable terminal device, or the like. The terminal device involved in the embodiments of the present disclosure may also be referred to as a terminal, user equipment (UE), an access terminal device, a vehicle terminal, an industrial control terminal, a UE unit, a UE station, a mobile station, a mobile station, a remote station, a remote terminal device, a mobile device, a UE terminal device, a wireless communication device, a UE agent, or a UE apparatus, or the like. The terminal device may be fixed or mobile.

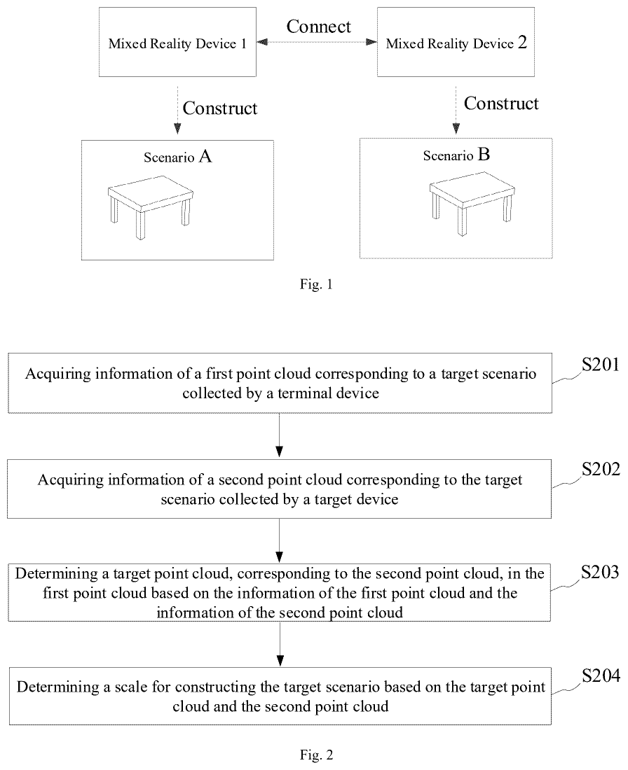

An application scenario according to an embodiment of the present disclosure is described below with reference to FIG. 1.

FIG. 1 is a schematic diagram of an application scenario according to an embodiment of the present disclosure. With reference to FIG. 1, a mixed reality device 1 and a mixed reality device 2 are included. The mixed reality device 1 is connected to the mixed reality device 2. Optionally, the mixed reality device 1 and the mixed reality device 2 may be connected in a wired or wireless (e.g., Bluetooth and wireless LAN) manner. The mixed reality device 1 may construct a scenario A based on data collected by the sensor, and the mixed reality device 2 may construct a scenario B based on data collected by the sensor. Both the scenario A and the scenario B may include a table (the scenario A and the scenario B are in the same environment), so that a multi-unit online effect can be realized.

It should be noted that FIG. 1 is only an example of this embodiment of the present disclosure, and is not a limitation of this embodiment of the present disclosure.

In related technologies, the mixed reality technology may introduce virtual scenario information in a real environment to enhance the sense of reality of user experience. At present, an MR device is usually a separate device for a user, and can collect environmental information in a real environment by means of a plurality of sensors, and perform scenario reconstruction based on the environmental information. For example, the MR device may reconstruct the real environment in a virtual scenario based on images in an environment captured by a camera apparatus; and the MR device may also generate information such as virtual props in the reconstructed scenario, so that the user may experience a real-virtual combined scenario via the MR device. However, when a plurality of users use a plurality of MR devices online, there is an error between scenarios reconstructed by the plurality of MR devices due to calibration errors of the sensors of each MR device. For example, as in the embodiment shown in FIG. 1, the scenario A reconstructed by the mixed reality device 1 includes a table, and the scenario B reconstructed by the mixed reality device 2 also includes a table. But due to calibration errors of the sensors between the mixed reality device 1 and the mixed reality device 2, the relative position of the table in the scenario A is different from the relative position of the table in the scenario B, which results in a large error between the scenarios reconstructed by the plurality of mixed reality devices, and brings poor online experience to a plurality of users.

In order to solve technical problems in the related technologies, an embodiment of the present disclosure provides a method for scenario processing, in which a terminal device may acquire information of a first point cloud corresponding to a target scenario collected by the terminal device and acquire information of a second point cloud corresponding to the target scenario collected by a target device; the terminal device may determine a first center coordinate of the first point cloud and a second center coordinate of the second point cloud, determine a transition matrix between a coordinate system of the target scenario collected by the terminal device and a coordinate system of the target scenario collected by the target device based on a relationship between points in the first point cloud and the first center coordinate, a relationship between points in the second point cloud and the second center coordinate, the first center coordinate and the second center coordinate, and determine the target point cloud, corresponding to the second point cloud, in the first point cloud based on the transition matrix, the information of the first point cloud and the information of the second point cloud; and the terminal device may determine a scale for constructing the target scenario based on the target point cloud and the second point cloud. In the above method, the terminal device may transit the first point cloud and the second point cloud to the same scenario based on the transition matrix, and accordingly the terminal device may accurately determine a matching point cloud. Since the terminal device may accurately determine a scale error in constructing the target scenario by the terminal device and the target device based on the matching point cloud, the terminal device accurately determines the scale for constructing the target scenario, thereby reducing the error between the reconstructed scenarios and improving the accuracy of scenario reconstruction.

The technical solution of the present disclosure and how the technical solution of the present disclosure solves the above technical problems are described in detail in the following specific embodiments. The following specific embodiments may be combined with each other, and the same or similar concepts or processes may not be repeated in some embodiments. The embodiments of the present disclosure will be described below in conjunction with the accompanying drawings.

FIG. 2 is a schematic flowchart of a method for scenario processing according to an embodiment of the present disclosure. With reference to FIG. 2, the method may include:

S201: acquiring information of a first point cloud corresponding to a target scenario collected by a terminal device.

The execution subject of this embodiment of the present disclosure may be a terminal device or an apparatus for scenario processing provided in the terminal device. The apparatus for scenario processing may be implemented by means of software, and may also be implemented by means of a combination of software and hardware. This embodiment of the present disclosure is not limited thereto.

The target scenario may be a real environment in which the terminal device is located. For example, if the terminal device is located indoors, the terminal device may determine that the target scenario is an indoor scenario; and if the terminal device is located outdoors, the terminal device may determine that the target scenario is an outdoor scenario. For example, the target scenario may be a scenario to be reconstructed. If the target scenario is a scenario 1, the terminal device may reconstruct a three-dimensional scenario of the scenario 1; and if the target scenario is a scenario 2, the terminal device may reconstruct a three-dimensional scenario of the scenario 2.

The first point cloud may be a point cloud collected by the terminal device in the target scenario. For example, the terminal device may acquire a plurality of images in the target scenario by means of a camera apparatus, and determine the first point cloud corresponding to the target scenario based on the plurality of images in the target scenario. Optionally, the first point cloud may also be a point cloud corresponding to any one of objects in the target scenario collected by the terminal device. This embodiment of the present disclosure is not limited thereto.

It should be noted that the information of the first point cloud may include coordinates of points in the first point cloud, descriptors of the first point cloud observed from a plurality of perspectives, and the like, and this embodiment of the present disclosure is not limited thereto.

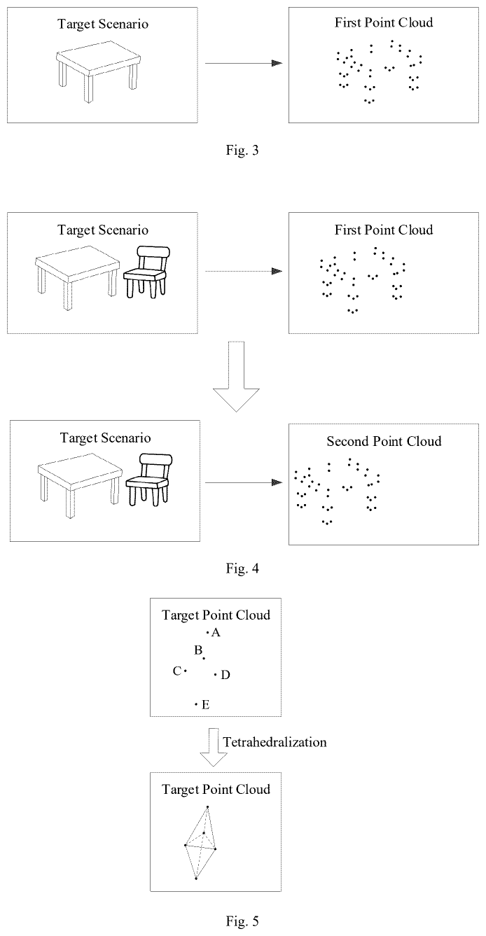

The first point cloud is described below with reference to FIG. 3.

FIG. 3 is a schematic diagram of a first point cloud according to an embodiment of the present disclosure. With reference to FIG. 3, a target scenario is included. The target scenario may include a table. The terminal device may collect a plurality of feature points of the table in the target scenario to obtain the first point cloud corresponding to the target scenario. Each point in the first point cloud may include a set of XYZ geometric coordinates. In this way, the terminal device may determine the position and shape of the table in the target scenario based on the first point cloud.

It should be noted that FIG. 3 is only an example of the first point cloud in this embodiment of the present disclosure, and is not a limitation on the number of the first point cloud.

S202: acquiring information of a second point cloud corresponding to the target scenario collected by a target device.

Optionally, the target device may be a device connected to the terminal device. For example, the terminal device and the target device may be mixed reality devices, and the terminal device and the target device may be connected based on a network, or based on a Bluetooth connection, or based on a data line connection. This embodiment of the present disclosure is not limited thereto.

The second point cloud may be a point cloud collected by the target device in the target scenario. For example, the target device may acquire a plurality of images in the target scenario by means of the camera apparatus, and determine the second point cloud corresponding to the target scenario based on the plurality of images in the target scenario. Optionally, the second point cloud may also be a point cloud corresponding to any one of objects in the target scenario collected by the target device. For example, the target scenario may include an object A and an object B. The target device may collect feature points of the object A to obtain the second point cloud; the target device may also collect feature points of the object B to obtain the second point cloud; and the target device may also collect feature points of the object A and the object B to obtain the second point cloud. This embodiment of the present disclosure is not limited thereto.

It should be noted that if the terminal device collects the feature points of the object A in a target environment to obtain the first point cloud, then the target device also collects the feature points of the object A in the target environment to obtain the second point cloud; if the terminal device collects the feature points of the object B in a target environment to obtain the first point cloud, then the target device also collects the feature points of the object B in the target environment to obtain the second point cloud.

It should be noted that the information of the second point cloud may include coordinates of points in the second point cloud, descriptors of the second point cloud observed from a plurality of perspectives, and the like, and this embodiment of the present disclosure is not limited thereto.

Optionally, the target device may send the second point cloud in the collected target scenario in real time, the terminal device may receive the second point cloud sent by the target device, and the terminal device may also acquire the second point cloud in the target scenario collected by the target device in accordance with any feasible implementation. This embodiment of the present disclosure is not limited thereto.

The second point cloud is described below with reference to FIG. 4.

FIG. 4 is a schematic diagram of a second point cloud according to an embodiment of the present disclosure. With reference to FIG. 4, a target scenario is included. The target scenario includes a table and a stool. The terminal device (not shown in FIG. 4) may collect feature points of the table in the target scenario to obtain the first point cloud, and accordingly, the target device may also collect feature points of the table in the target scenario to obtain the second point cloud. There are calibration errors between sensors of the terminal device and sensors of the target device, or the model or parameters of the terminal device and the target device are different, and accordingly, there is a scale error between the first point cloud determined by the terminal device and the second point cloud determined by the target device.

S203: determining a target point cloud, corresponding to the second point cloud, in the first point cloud based on the information of the first point cloud and the information of the second point cloud.

The target point cloud may be a point cloud, corresponding to the position of the second point cloud, in the first point cloud. For example, if the first point cloud collected by the terminal device corresponds to the position of the second point cloud collected by the target device in the target scenario, then the terminal device may determine corresponding point clouds in the first point cloud and the second point cloud as target point clouds. For example, the terminal device and the target device may collect the first point cloud and the second point cloud in the target scenario with the same or similar predetermined rules (e.g., both collecting point clouds at the same position and in the same direction), and it can be understood that there will be a large number of corresponding points, i.e., the target point cloud, in the first point cloud and the second point cloud.

The terminal device may determine the target point cloud corresponding to the second point cloud in accordance with the following feasible implementation: determining first center coordinates of the first point cloud and second center coordinates of the second point cloud, determining a transition matrix between a coordinate system of the target scenario collected by the terminal device and a coordinate system of the target scenario collected by the target device based on a relationship between points in the first point cloud and the first center coordinate, a relationship between points in the second point cloud and the second center coordinate, the first center coordinate and the second center coordinate; and determining the target point cloud, corresponding to the second point cloud, in the first point cloud based on the transition matrix, the information of the first point cloud and the information of the second point cloud.

The transition matrix may be used for indicating a transition relationship between the coordinate system of the target scenario collected by the terminal device and the coordinate system of the target scenario collected by the target device. For example, the transition matrix may transit the first point cloud of the target scenario collected by the terminal device into the coordinate system of the target scenario collected by the target device, and the transition matrix may also transit the second point cloud of the target scenario collected by the target device into the coordinate system of the target scenario collected by the terminal device. This embodiment of the present disclosure is not limited thereto. In this way, the terminal device may transit the first point cloud and the second point cloud into the same coordinate system based on the transition matrix, and thus can accurately determine the target point cloud corresponding to the second point cloud.

The first center coordinates may be coordinates of a center point corresponding to the first point cloud, and the second center coordinates may be coordinates of a center point corresponding to the second point cloud. For example, if a first point cloud A is (1, 1, 1) and a first point cloud B is (3, 3, 3), then the first center coordinates of the first point cloud A and the first point cloud B are (2, 2, 2). It should be noted that the terminal device may determine the first center coordinate of the first point cloud in accordance with any feasible implementation, and this embodiment of the present disclosure is not limited thereto. Moreover, the terminal device determines the second center coordinate of the second point cloud by the same method as the method for the terminal device to determine the first center coordinates, and this embodiment of the present disclosure will not be repeated herein.

Optionally, the relationship between points in the first point cloud and the first center coordinate may be a positional relationship between the point in the first point cloud and the first center coordinate. For example, the relationship between points in the first point cloud and the first center coordinate may be a distance between the point in the first point cloud and the first center coordinate.

It should be noted that the terminal device may determine the distance between the point in the first point cloud and the first center coordinate (e.g., determine the coordinate of the point in the first point cloud, and determine the distance between the point in the first point cloud and the first center coordinate based on the coordinate of the point in the first point cloud and the first center coordinate) in accordance with any feasible implementation, and this embodiment of the present disclosure is not limited thereto.

Optionally, the relationship between points in the second point cloud and the second center coordinate may be a positional relationship between the point in the second point cloud and the second center coordinate. For example, the relationship between points in the second point cloud and the second center coordinate may be a distance between the point in the second point cloud and the second center coordinate.

It should be noted that the terminal device may determine the distance between the point in the second point cloud and the second center coordinate (e.g., determine the coordinate of the point in the second point cloud, and determine the distance between the point in the second point cloud and the second center coordinate based on the coordinate of the point in the second point cloud and the second center coordinate) in accordance with any feasible implementation, and this embodiment of the present disclosure is not limited thereto.

The terminal device determines a transition matrix between a coordinate system of the target scenario collected by the terminal device and a coordinate system of the target scenario collected by the target device based on a relationship between points in the first point cloud and the first center coordinate, a relationship between points in the second point cloud and the second center coordinate, the first center coordinate and the second center coordinate, which specifically includes: determining a translation distance based on the first center coordinate and the second center coordinate, determining a rotation angle based on the relationship between the point in the first point cloud and the first center coordinate and the relationship between the point in the second point cloud and the second center coordinate, and determining a rotation matrix based on the translation distance and the rotation angle.

Optionally, the translation distance may be a distance between the first center coordinate and the second center coordinate. For example, if the first center coordinate is (1, 1, 1) and the second center coordinate is (1, 1, 2), the distance between the first center coordinate and the second center coordinate is 1, i.e., the translation distance is 1. It should be noted that the terminal device may determine the translation distance in accordance with any feasible implementation, and this embodiment of the present disclosure is not limited thereto.

Optionally, the terminal device may determine a first matrix based on a plurality of first distances between points in the first point cloud and the first center coordinate, determine a second matrix based on a plurality of second distances between points in the second point cloud and the second center coordinate, and calculate a rotation angle between the first matrix and the second matrix to obtain the rotation angle of the transition matrix. For example, after calculating a plurality of first distances, the terminal device may establish a first matrix based on a relationship between the points in the first point cloud and the first center coordinate, and similarly, the terminal device may establish a second matrix, and after calculating a rotation angle between the first matrix and the second matrix, the terminal device may determine the rotation angle as a rotation angle of the transition matrix.

It should be noted that the terminal device may calculate the rotation angle between the first matrix and the second matrix in accordance with any feasible implementation, and this embodiment of the present disclosure is not limited thereto.

Optionally, the terminal device may determine the transition matrix according to the following formula:

T_{w}_{ⱼ}_{w}_{ᵢ}=T_{w}_{ⱼ}ⱼT_{w}_{ᵢ}ⱼ⁻¹

where T_{w}_{ⱼ}_{w}_{ᵢ} is the transition matrix, T_{w}_{ᵢ}ⱼ may be the position of the terminal device in the target scenario collected by the terminal device, and T_{w}_{ⱼ}ⱼ is the position of the terminal device in the target scenario collected by the target device.

It should be noted that each point cloud in this embodiment of the present disclosure may include descriptors (e.g., ORB, SIFT, and superpoint) of the point cloud observed from different perspectives, and the terminal device determines the transition matrix based on a matching relationship between the descriptors of the first point cloud and the descriptors of the second point cloud, and this embodiment of the present disclosure is not limited thereto.

S204: determining a scale for constructing the target scenario based on the target point cloud and the second point cloud.

The scale of the target scenario may be a scale at which the terminal device constructs the target scenario. For example, a sensor collects the position (10, 10, 10) of the table relative to the origin, and if the scale of the target scenario is 0.9, the terminal device may adjust the position of the table relative to the origin to be (9, 9, 9) when constructing a three-dimensional map of the target scenario.

The terminal device may determine the scale for constructing the target scenario in accordance with the following feasible implementation: determining at least one first line segment in the target point cloud; determining at least one second line segment, corresponding to the first line segment, in the second point cloud; and determining the scale for constructing the target scenario based on lengths of at least one pair of the first line segment and the second line segment. In this way, the terminal device may determine a scale error between the target scenario collected by the terminal device and the target scenario collected by the target device based on a difference in the lengths of at least one pair of the first line segment and the second line segment, and thus can accurately determine the scale at which the terminal device constructs the target scenario.

Optionally, the first line segment may be a line segment obtained by connecting points in the target point cloud. For example, a point A in the target point cloud is connected to a point B in the target point cloud to obtain a line segment 1, the point B in the target point cloud is connected to a point C in the target point cloud to obtain a line segment 2, a point a in the second point cloud is connected to a point b in the second point cloud to obtain a line segment 3, and a point c in the second point cloud is connected to a point d in the second point cloud to obtain a line segment 4. The terminal device may determine the line segment 1 and the line segment 2 as the first line segment, and the line segment 3 and line segment 4 as the second line segment.

Optionally, the second line segment may be a line segment obtained by connecting points, corresponding to the target point cloud, in the second point cloud. For example, the point A in the target point cloud corresponds to the point a in the second point cloud, the point B in the target point cloud corresponds to the point b in the second point cloud, the point A in the target point cloud is connected to the point B in the target point cloud to obtain the line segment 1, and the point a in the second point cloud is connected to the point b in the second point cloud to obtain the line segment 2. The terminal device may determine the line segment 1 as the first line segment, and may also determine the line segment 2 as the second line segment corresponding to the first line segment.

Optionally, the terminal device may determine the at least one first line segment and the at least one second line segment in accordance with the following feasible implementation: performing tetrahedralization on the target point cloud to obtain at least one first tetrahedron; and performing tetrahedralization on a point cloud, corresponding to the target point cloud, in the second point cloud to obtain at least one second tetrahedron.

The first tetrahedron may be a tetrahedron constructed based on the target point cloud. For example, the terminal device may perform tetrahedralization on points in the target point cloud to obtain a first tetrahedron. For example, the terminal device may construct two tetrahedra based on 5 points in the target point cloud.

The second tetrahedron may be a tetrahedron constructed based on points, corresponding to the target point cloud, in the second point cloud. For example, the terminal device may, in the second point cloud, determine points corresponding to the target point cloud, and perform tetrahedralization based on the points corresponding to the target point cloud to obtain a plurality of second tetrahedra.

The first tetrahedron is described below with reference to FIG. 5.

FIG. 5 is a schematic diagram of a first tetrahedron according to an embodiment of the present disclosure. With reference to FIG. 5, a target point cloud is included. The target point cloud may include a point A, a point B, a point C, a point D, and a point E. The terminal device may perform tetrahedralization on the points in the target point cloud, i.e., connect the point A, the point B, the point C, the point D, and the point E to obtain two first tetrahedra.

It should be noted that the terminal device may perform tetrahedralization on the points in the target point cloud as well as the second point cloud corresponding to the target point cloud, in accordance with any feasible implementation, and this embodiment of the present disclosure is not limited thereto.

The first line segment is an edge of the first tetrahedron formed based on the points in the target point cloud, and the second line segment is an edge of the second tetrahedron formed based on the points in the second point cloud corresponding to the target point cloud. For example, the first tetrahedron includes a plurality of edges, each edge may be a first line segment; and the second tetrahedron includes a plurality of edges, each edge may be a second line segment. For example, a first tetrahedron may be obtained after the terminal device performs tetrahedralization on the points in the target point cloud, and the terminal device may determine any one of the edges of the first tetrahedron as the first line segment. For example, as in the embodiment shown in FIG. 5, the terminal device may determine an edge between the point A and the point C in the target point cloud as the first line segment, and the terminal device may also determine an edge between the point D and the point E in the target point cloud as the first line segment. This embodiment of the present disclosure is not limited thereto.

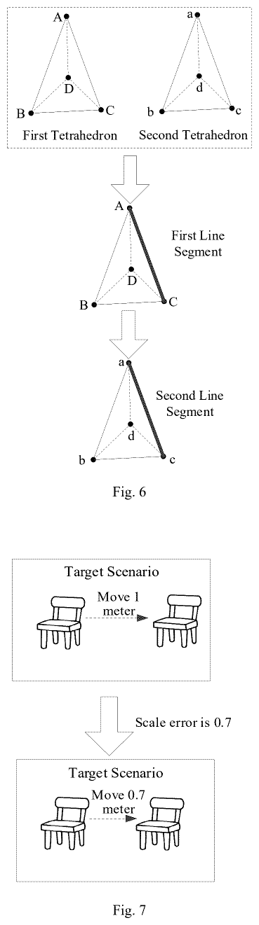

The first line segment and the second line segment are described below with reference to FIG. 6.

FIG. 6 is a schematic diagram of a first line segment and a second line segment according to an embodiment of the present disclosure. With reference to FIG. 6, a first tetrahedron and a second tetrahedron corresponding to the first tetrahedron are included. The first tetrahedron includes a point A, a point B, a point C, and a point D, and the second tetrahedron includes a point a, a point b, a point c, and a point d.

With reference to FIG. 6, the point A corresponds to the point a, the point B corresponds to the point b, the point C corresponds to the point c, and the point D corresponds to the point d. The terminal device determines an edge connecting the point A to the point C as the first line segment. Therefore, the terminal device may determine an edge connecting the point a to the point c as the second line segment in the second tetrahedron.

The terminal device determines a scale for constructing the target scenario based on lengths of at least one pair of the first line segment and the second line segment, which may specifically include: determining a scale error between the target scenario collected by the terminal device and the target scenario collected by the target device based on a difference in the lengths of at least one pair of the first line segment and the second line segment; and determining the scale at which the terminal device constructs the target scenario based on the scale error.

The difference in the lengths of the first line segment and the second line segment may be calculated according to the following formula:

$$e r {r}_{u ν} ( λ ) = {( \vert {e}_{u ν} \vert - λ \vert {\tilde{e}}_{u ν} \vert )}^{2}$$

where u is the first line segment, v is the second line segment, eᵤᵥ is the length of the first line segment, \tilde{e}ᵤᵥ is the length of the second line segment, and λ is the scale error to be solved.

The terminal device determines the scale error between the target scenario collected by the terminal device and the target scenario collected by the target device, which may be specifically as shown in the following formula:

$$err ( λ ) = \sum {( \vert {e}_{u ν} \vert - λ \vert {\tilde{e}}_{u ν} \vert )}^{2}$$

where u is the first line segment, v is the second line segment, eᵤᵥ is the length of the first line segment, \tilde{e}ᵤᵥ is the length of the second line segment, and λ is the scale error to be solved.

The terminal device solves λ in the above formula to obtain the scale error between the target scenario collected by the terminal device and the target scenario collected by the target device, and may adjust the scale of the target scenario collected by the terminal device based on the scale error. For example, the scale error is 0.9, if the terminal device determines that an object moves 1 meter in the target scenario based on data collected by the sensor, the terminal device may adjust 1 meter to 0.9 meter; if the terminal device determines that the object is located at the position (100, 100, 100) relative to the origin in the target scenario based on data collected by the sensor, the terminal device may adjust the position of the object to be (90, 90, 90) relative to the origin, so that the scale of the target scenario collected by the terminal device is the same as the scale of the target scenario collected by the target device. In this way, the terminal device and the target device may jointly construct a three-dimensional map of the current target scenario (e.g., the terminal device is responsible for constructing a part of the three-dimensional map, and the target device is responsible for constructing the rest of the three-dimensional map), thereby improving the efficiency of constructing the target scenario.

With reference to FIG. 7, the following describes that the terminal device determines the scale at which it constructs the target scenario based on the scale error.

FIG. 7 is a schematic diagram of determining a scale for constructing a target scenario according to an embodiment of the present disclosure. With reference to FIG. 7, a target scenario collected by the terminal device is included. The target scenario collected by the terminal device includes a chair. The terminal device (not shown in FIG. 7) may determine that the chair moves 1 meter to the right in the target scenario based on data collected by the sensor. The terminal device determines that the scale error is 0.7. In the actual processing, the terminal device may construct a target scenario in which the chair moves 0.7 meters to the right. In this way, there is a small error between the target scenarios constructed after the terminal device and the target device are online, thus improving the user experience.

It should be noted that the terminal device may adjust any parameters related to the length, such as the position of the object in the target scenario, the moving distance, and the like, based on the scale at which the terminal device constructs the target scenario, and this embodiment of the present disclosure is not limited thereto.

An embodiment of the present disclosure provides a method for scenario processing, in which a terminal device may acquire information of a first point cloud corresponding to a target scenario collected by the terminal device, acquire information of a second point cloud corresponding to the target scenario collected by a target device, determine a target point cloud, corresponding to the second point cloud, in the first point cloud based on the information of the first point cloud and the information of the second point cloud, determine a scale for constructing the target scenario, determine at least one first line segment in the target point cloud, determine at least one second line segment corresponding to the first line segment in the second point cloud, and determine the scale for constructing the target scenario based on lengths of at least one pair of the first line segment and the second line segment. In the above method, the terminal device may transit the first point cloud and the second point cloud into the same scenario based on a rotation matrix, and thus can accurately determine the first point cloud and the second point cloud matching with each other. Because the terminal device may accurately determine a scale error between the target scenario collected by the terminal device and the target scenario collected by the target device based on the difference in the lengths of the first line segment and the second line segment that are constructed by the first point cloud and the second point cloud matching with each other, the terminal device may accurately determine the scale for constructing the target scenario, thereby reducing the error between the target scenarios constructed by a plurality of devices, and improving the user experience.

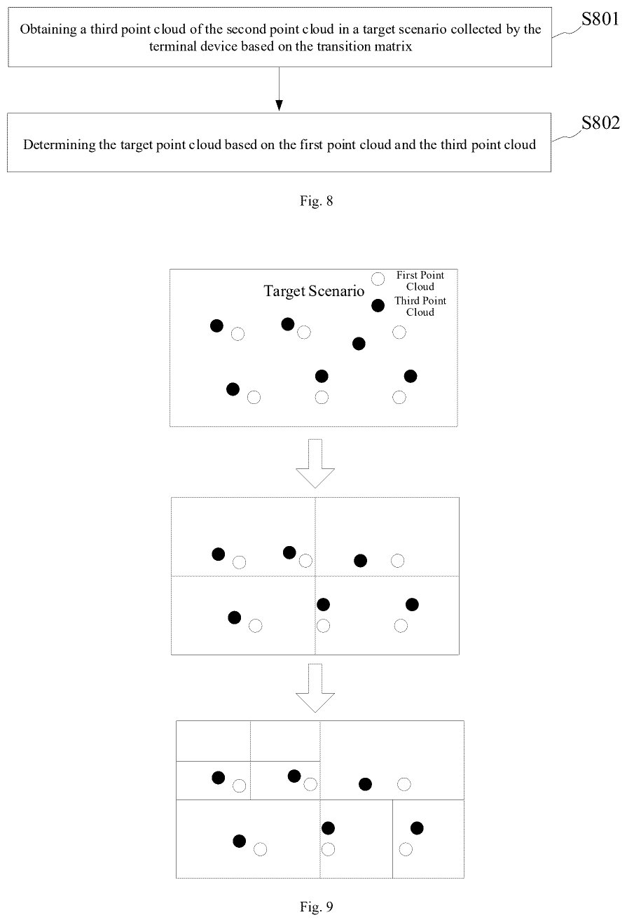

Based on the embodiment shown in FIG. 2, the following describes, with reference to FIG. 8, the process of determining a target point cloud, corresponding to the second point cloud, in the first point cloud based on the transition matrix, the information of the first point cloud and the information of the second point cloud, in the above method for scenario processing.

FIG. 8 is a schematic diagram of a method for determining a target point cloud according to an embodiment of the present disclosure. With reference to FIG. 8, the method includes the following steps:

S801: obtaining a third point cloud of the second point cloud in a target scenario collected by the terminal device based on the transition matrix.

The third point cloud may be a point cloud of the second point cloud that is transited into the target scenario collected by the terminal device. For example, after the terminal device determines the transition matrix between the coordinate system of the target scenario collected by the terminal device and the coordinate system of the target scenario collected by the target device, the coordinates of the points in the second point cloud in the target scenario collected by the target device may be processed based on the transition matrix, to obtain the coordinates of the points in the second point cloud in the target scenario collected by the terminal device.

The terminal device may perform transition processing on the second point cloud to obtain the third point cloud according to the following formula:

$${P}_{j}^{k} = {T}_{{w}_{j} {w}_{i}} * {P}_{i}^{k}$$

where Pⱼ^{k} is the coordinate of a point in the third point cloud, T_{w}_{ⱼ}_{wi} is the transition matrix, and Pᵢ^{k} is the coordinate of a point in the second point cloud.

It should be noted that the terminal device may also determine the coordinate of each point in the third point cloud in accordance with any feasible implementation, and this embodiment of the present disclosure is not limited thereto.

It should be noted that the terminal device may also transit the second point cloud to the third point cloud in accordance with any feasible implementation, and this embodiment of the present disclosure is not limited thereto.

S802: determining the target point cloud based on the first point cloud and the third point cloud.

The terminal device may determine the target point cloud in accordance with the following feasible implementation: constructing an octree based on the third point cloud, and determining a point cloud in the first point cloud that is closest to the third point cloud as the target point cloud based on the first point cloud and the octree.

For example, the third point cloud is obtained after the terminal device transits the second point cloud into the target scenario collected by the terminal device, and the terminal device may calculate a point of the first point cloud that is closest to the third point cloud based on the coordinates of each point in the third point cloud and the information of the first point cloud, and that point of the first point cloud may be determined as the target point cloud. For example, the first point cloud includes a point 1 and a point 2, and the second point cloud includes point 3. After the terminal device processes the second point cloud based on the transition matrix, a third point cloud can be obtained. The third point cloud includes a point 4. If the point 4 is closest to the point 1, then the terminal device may determine the point 1 (a point in the first point cloud) as a point in the target point cloud corresponding to the point 3 (a point in the second point cloud). If the point 4 is closest to the point 2, then the terminal device may determine the point 2 (a point in the first point cloud) as a point in the target point cloud corresponding to the point 3 (a point in the second point cloud). If the distance between the point 4 and the point 1 is the same as the distance between the point 4 and the point 2, then the terminal device may determine the point 1 (the point in the first point cloud) or the point 2 (the point in the first point cloud) as a point in the target point cloud corresponding to the point 3 (the point in the second point cloud).

Optionally, the terminal device may construct an octree based on the third point cloud, and then determine, a point cloud in the first point cloud that is closest to the third point cloud as the target point cloud based on the first point cloud and the octree.

Optionally, for any one point in the third point cloud, the terminal device may determine, among a plurality of points in the first point cloud, a target point that is closest to the point in the third point cloud, and then obtains the target point cloud based on the plurality of target points.

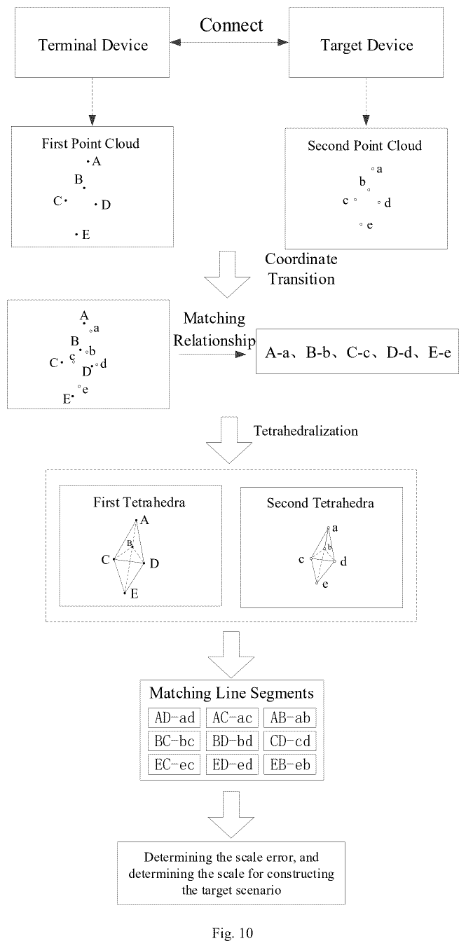

A method for the terminal device to determine a target point cloud is described below with reference to FIG. 9.

FIG. 9 is a schematic diagram of determining a target point cloud according to an embodiment of the present disclosure. With reference to FIG. 9, a target scenario collected by the terminal device is included. The target scenario may include a first point cloud and a third point cloud (white circles are points in the first point cloud and black circles are points in the third point cloud). The terminal device (not shown in FIG. 9) may divide the target scenario into 4 regions (the octree refers to the spatial location, and the embodiment shown in FIG. 9 is a planar example of the octree). A first region includes 2 points in the first point cloud and 2 points in the third point cloud, a second region includes 1 point in the first point cloud and 1 point in the third point cloud, and a third region includes 1 point in the first point cloud and 1 point in the third point cloud, and a fourth region includes 2 points in the first point cloud and 2 points in the third point cloud.

With reference to FIG. 9, both the second region and the third region include 1 point in the first point cloud and 1 point in the third point cloud, and accordingly the terminal device may determine the point in the first point cloud in the second region as a point in the target point cloud, and the terminal device may determine the point in the first point cloud in the third region as a point in the target point cloud. The terminal device may divide the first region and the fourth region again.

With reference to FIG. 9, among four sub-regions divided from the first region, a third sub-region and a fourth sub-region both include 1 point in the first point cloud and 1 point in the third point cloud, and accordingly, the terminal device may determine the points in the first point cloud as points in the target point cloud. Each of two sub-regions divided from the fourth region includes 1 point in the first point cloud and 1 point in the third point cloud, and accordingly, the terminal device may determine the points in the first point cloud as points in the target point cloud in the fourth region, so as to obtain the target point cloud based on the determined target points. In this way, the terminal device can accurately determine the target point cloud corresponding to the second point cloud, so that the accuracy of the scale error can be improved.

It should be noted that if a region includes a plurality of points of the first point cloud and 1 point of the third point cloud, the terminal device may obtain a point in the first point cloud that is closest to a point in the third point cloud (i.e., the two points are points that are corresponding to each other) based on the matching between descriptors corresponding to the a plurality of points of the first point cloud and a descriptor corresponding to the 1 point of the third point cloud, and this embodiment of the present disclosure is not limited thereto.

An embodiment of the present disclosure provides a method for determining a target point cloud, which includes obtaining a third point cloud of the second point cloud in the target scenario collected by the terminal device based on the transition matrix; constructing an octree based on the third point cloud; and determining a point cloud in the first point cloud that is closest to the third point cloud as the target point cloud based on the first point cloud and the octree. In this way, the terminal device may accurately determine the target point cloud corresponding to the second point cloud, and may accurately determine the scale error between the target scenario collected by the terminal device and the target scenario collected by the target device, thereby reducing the error in the process that a plurality of devices jointly construct the target scenario.

Based on any of the above embodiments, the process of the above method for scenario processing is described below with reference to FIG. 10.

FIG. 10 is a process diagram of a method for scenario processing according to an embodiment of the present disclosure. With reference to FIG. 10, a terminal device and a target device are included. The terminal device is connected to the target device, the terminal device may collect a first point cloud in the target scenario, and the target device may collect a second point cloud in the target scenario. The first point cloud may include a point A, a point B, a point C, a point D, and a point E (for example only, not a limitation), and the second point cloud may include a point a, a point b, a point c, a point d, and a point e (for example only, not a limitation).

With reference to FIG. 10, after the terminal device determines a transition matrix, it may transit the second point cloud to obtain a third point cloud, determine a target point cloud corresponding to the second point cloud (the first point cloud being the target point cloud) based on the first point cloud and the third point cloud, and obtain a matching relationship between the points in the second point cloud and points in the target point cloud. The matching relationship includes: the point A matching with point a, the point B matching with the point b, the point C matching with the point c, the point D matching with the point d, and the point E matching with the point e.

With reference to FIG. 10, the terminal device may perform tetrahedralization on the target point cloud to obtain a plurality of first tetrahedra, and the terminal device may perform tetrahedralization on the second point cloud to obtain a plurality of second tetrahedra. The terminal device may determine matching line segments between the plurality of first tetrahedra and the plurality of second tetrahedra.

With reference to FIG. 10, the matching line segments may include: a line segment AD matching with a line segment ad, a line segment AC matching with a line segment ac, a line segment AB matching with a line segment ab, a line segment BC matching with a line segment bc, a line segment BD matching with a line segment bd, a line segment CD matching with a line segment cd, a line segment EC matching with a line segment ec, a line segment ED matching with a line segment ed, and a line segment EB matching with a line segment eb. The terminal device may determine the scale error between the target scenario collected by the terminal device and the target scenario collected by the target device based on an error of each pair of matching line segments, and determine the scale at which the terminal device constructs the target scenario.

In this way, because the terminal device can accurately determine the scale error between the target scenario collected by the terminal device and the target scenario collected by the target device based on the errors of the matching line segments, and the matching line segments are determined by line segments between points in the target point cloud whose positions correspond to each other and line segments between points in the second point cloud, the accuracy of the scale error is high. In addition, the terminal device and the target device may jointly construct the target scenarios with the same scale, so that the efficiency of constructing the target scenario can be improved.

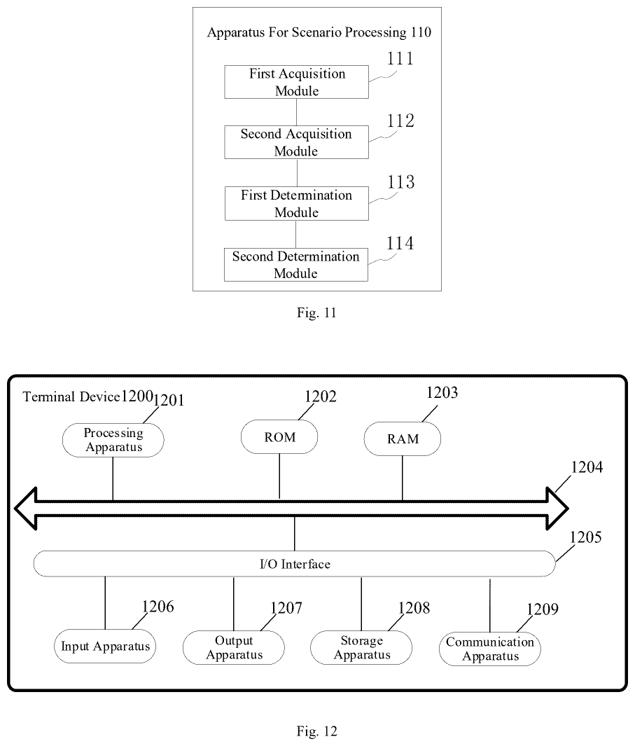

FIG. 11 is a schematic structural diagram of an apparatus for scenario processing according to an embodiment of the present disclosure. With reference to FIG. 11, the apparatus for scenario processing 110 includes a first acquisition module 111, a second acquisition module 112, a first determination module 113, and a second determination module 114.

The first acquisition module 111 is configured to acquire information of a first point cloud corresponding to a target scenario collected by a terminal device.

The second acquisition module 112 is configured to acquire information of a second point cloud corresponding to a target scenario collected by a target device.

The first determination module 113 is configured to determine a target point cloud, corresponding to the second point cloud, in the first point cloud based on the information of the first point cloud and the information of the second point cloud.

The second determination module 114 is configured to determine a scale for constructing the target scenario based on the target point cloud and the second point cloud.

According to one or more embodiments of the present disclosure, the first determination module 113 is specifically configured to:
determine a first center coordinate of the first point cloud and a second center coordinate of the second point cloud;
determine a transition matrix between a coordinate system of the target scenario collected by the terminal device and a coordinate system of the target scenario collected by the target device based on a relationship between points in the first point cloud and the first center coordinate, a relationship between points in the second point cloud and the second center coordinate, the first center coordinate and the second center coordinate; and
determine the target point cloud, corresponding to the second point cloud, in the first point cloud based on the transition matrix, the information of the first point cloud and the information of the second point cloud.

According to one or more embodiments of the present disclosure, the first determination module 113 is specifically configured to:
obtain a third point cloud of the second point cloud in the target scenario collected by the terminal device based on the transition matrix; and
determine the target point cloud based on the first point cloud and the third point cloud.

According to one or more embodiments of the present disclosure, the first determination module 113 is specifically configured to:
construct an octree based on the third point cloud; and
determine a point cloud in the first point cloud that is closest to the third point cloud as the target point cloud based on the first point cloud and the octree.

According to one or more embodiments of the present disclosure, the second determination module 114 is specifically configured to:
determine at least one first line segment in the target point cloud;
determine at least one second line segment, corresponding to the first line segment, in the second point cloud;
and determine the scale for constructing the target scenario based on lengths of at least one pair of the first line segment and the second line segment.

According to one or more embodiments of the present disclosure, the second determination module 114 is further configured to:
perform tetrahedralization on the target point cloud to obtain at least one first tetrahedron; and
perform tetrahedralization on a point cloud, corresponding to the target point cloud, in the second point cloud to obtain at least one second tetrahedron;
where the first line segment is an edge of the first tetrahedron and the second line segment is an edge of the second tetrahedron.

According to one or more embodiments of the present disclosure, the second determination module 114 is specifically configured to:
determine a scale error between the target scenario collected by the terminal device and the target scenario collected by the target device based on a difference in the lengths of at least one pair of the first line segment and the second line segment; and
determine the scale at which the terminal device constructs the target scenario based on the scale error.

The apparatus for scene processing provided by the embodiments of the present disclosure may be used to perform the technical solutions of the method embodiments described above, which are similar in realization principles and technical effects, and the embodiments will not be repeated herein.

FIG. 12 is a schematic structural diagram of a terminal device according to an embodiment of the present disclosure. Referring to FIG. 12, FIG. 12 illustrates a schematic structural diagram of a terminal device 1200 suitable for implementing embodiments of the present disclosure. The terminal device may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The terminal device illustrated in FIG. 12 is merely an example, and should not pose any limitation to the functions and the range of use of the embodiments of the present disclosure.

As illustrated in FIG. 12, the terminal device 1200 may include a processing apparatus 1201 (e.g., a central processing unit, a graphics processing unit, etc.), which can perform various suitable actions and processing according to a program stored in a read-only memory (ROM) 1202 or a program loaded from a storage apparatus 1208 into a random-access memory (RAM) 1203. The RAM 1203 further stores various programs and data required for operations of the terminal device 1200. The processing apparatus 1201, the ROM 1202, and the RAM 1203 are interconnected by means of a bus 1204. An input/output (I/O) interface 1205 is also connected to the bus 1204.

Usually, the following apparatus may be connected to the I/O interface 1205: an input apparatus 1206 including, for example, a touch screen, a touch pad, a keyboard, a mouse, a camera, a microphone, an accelerometer, a gyroscope, or the like; an output apparatus 1207 including, for example, a liquid crystal display (LCD), a loudspeaker, a vibrator, or the like; a storage apparatus 1208 including, for example, a magnetic tape, a hard disk, or the like; and a communication apparatus 1209. The communication apparatus 1209 may allow the terminal device 1200 to be in wireless or wired communication with other devices to exchange data. While FIG. 12 illustrates the terminal device 1200 having various apparatuses, it should be understood that not all of the illustrated apparatuses are necessarily implemented or included. More or fewer apparatuses may be implemented or included alternatively.

Particularly, according to some embodiments of the present disclosure, the processes described above with reference to the flowcharts may be implemented as a computer software program. For example, some embodiments of the present disclosure include a computer program product, which includes a computer program carried by a computer-readable medium. The computer program includes program codes for performing the methods shown in the flowcharts. In such embodiments, the computer program may be downloaded online through the communication apparatus 1209 and installed, or may be installed from the storage apparatus 1208, or may be installed from the ROM 1202. When the computer program is executed by the processing apparatus 1201, the above-mentioned functions defined in the methods of some embodiments of the present disclosure are performed.

It should be noted that the above-mentioned computer-readable medium in the present disclosure may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present disclosure, the computer-readable storage medium may be any tangible medium containing or storing a program that can be used by or in combination with an instruction execution system, apparatus or device. In the present disclosure, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

The above-mentioned computer-readable medium may be included in the above-mentioned terminal device, or may also exist alone without being assembled into the terminal device.

The above-mentioned computer-readable medium carries one or more programs, and when the one or more programs are executed by the terminal device, the terminal device is caused to implement the method described in the above embodiment.

At least one embodiment of the present disclosure provides a non-transitory computer-readable storage medium which stores computer-executable instructions, where a processor upon executing the computer-executable instructions, implements the method described in the above embodiment.

At least one embodiment of the present disclosure provides a computer program product including computer programs, where the computer programs upon being executed by a processor implements the method described in the above embodiment.

The computer program codes for performing the operations of the present disclosure may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present disclosure. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The units involved in the embodiments of the present disclosure may be implemented in software or hardware. The name of the unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present disclosure, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

It should be noted that modifications of “one” and “more” mentioned in the present disclosure are schematic rather than restrictive, and those skilled in the art should understand that unless otherwise explicitly stated in the context, it should be understood as “one or more”.

The names of the messages or information interacted with between the plurality of apparatuses of the embodiments of the present disclosure are used for illustrative purposes only and are not intended to place limitations on the scope of those messages or information.

It can be understood that before using the technical solutions disclosed in various embodiments of the present disclosure, users should be informed of the types, scope of use, use scenarios, etc. of personal information involved in the present disclosure in an appropriate way according to relevant laws and regulations and be authorized by the users.

For example, in response to receiving an active request from a user, prompt information is sent to the user to clearly prompt the user that an operation requested by the user to be performed will require acquisition and use of personal information of the user. Therefore, the user can independently choose whether to provide personal information to software or hardware such as a computer device, an application program, a server or a storage medium that performs the operations of the technical solution of the present disclosure according to the prompt information. As an optional but non-limiting implementation, in response to receiving the active request of the user, the prompt information may be sent to the user by, for example, a pop-up window, in which the prompt information can be presented in the form of text. In addition, the pop-up window can also carry a selection control for the user to choose “agree” or “disagree” to provide personal information to the computer device.

It can be understood that the above process of notifying and acquiring user authorization is only schematic, and does not limit the implementation of the present disclosure, and other ways meeting relevant laws and regulations may also be applied to the implementation of the present disclosure.

It is to be understood that the data involved in the present technical solution (including, but not limited to, the data itself, the acquisition or use of the data) should comply with the requirements of the corresponding laws and regulations and related provisions. The data may include information, parameters and messages, such as cut flow indication information.

At least one embodiment of the present disclosure provides a method for scene processing, which includes:
acquiring information of a first point cloud corresponding to a target scenario collected by a terminal device;
acquiring information of a second point cloud corresponding to the target scenario collected by a target device;
determining a target point cloud, corresponding to the second point cloud, in the first point cloud based on the information of the first point cloud and the information of the second point cloud; and
determining a scale for constructing the target scenario based on the target point cloud and the second point cloud.

According to one or more embodiments of the present disclosure, determining a target point cloud, corresponding to the second point cloud, in the first point cloud based on the information of the first point cloud and the information of the second point cloud, includes:
determining a first center coordinate of the first point cloud and a second center coordinate of the second point cloud;
determining a transition matrix between a coordinate system of the target scenario collected by the terminal device and a coordinate system of the target scenario collected by the target device based on a relationship between points in the first point cloud and the first center coordinate, a relationship between points in the second point cloud and the second center coordinate, the first center coordinate and the second center coordinate; and
determining the target point cloud, corresponding to the second point cloud, in the first point cloud based on the transition matrix, the information of the first point cloud and the information of the second point cloud.

According to one or more embodiments of the present disclosure, determining the target point cloud, corresponding to the second point cloud, in the first point cloud based on the transition matrix, the information of the first point cloud and the information of the second point cloud, includes:
obtaining a third point cloud of the second point cloud in the target scenario collected by the terminal device based on the transition matrix; and
determining the target point cloud based on the first point cloud and the third point cloud.

According to one or more embodiments of the present disclosure, determining the target point cloud based on the first point cloud and the third point cloud, includes:
constructing an octree based on the third point cloud; and
determining a point cloud in the first point cloud that is closest to the third point cloud as the target point cloud based on the first point cloud and the octree.

According to one or more embodiments of the present disclosure, determining a scale for constructing the target scenario based on the target point cloud and the second point cloud, includes:
determining at least one first line segment in the target point cloud;
determining at least one second line segment, corresponding to the first line segment, in the second point cloud; and
determining the scale for constructing the target scenario based on lengths of at least one pair of the first line segment and the second line segment.

According to one or more embodiments of the present disclosure, the method further includes:
performing tetrahedralization on the target point cloud to obtain at least one first tetrahedron; and
performing tetrahedralization on a point cloud, corresponding to the target point cloud, in the second point cloud to obtain at least one second tetrahedron,
where the first line segment is an edge of the first tetrahedron and the second line segment is an edge of the second tetrahedron.

According to one or more embodiments of the present disclosure, determining the scale for constructing the target scenario based on lengths of at least one pair of the first line segment and the second line segment, includes:
determining a scale error between the target scenario collected by the terminal device and the target scenario collected by the target device based on a difference in the lengths of at least one pair of the first line segment and the second line segment; and
determining the scale at which the terminal device constructs the target scenario based on the scale error.

At least one embodiment of the present disclosure provides an apparatus for scene processing, which includes a first acquisition module, a second acquisition module, a first determination module, and a second determination module, where
the first acquisition module is configured to acquire information of a first point cloud corresponding to a target scenario collected by a terminal device;
the second acquisition module is configured to acquire information of a second point cloud corresponding to the target scenario collected by a target device;
the first determination module is configured to determine a target point cloud, corresponding to the second point cloud, in the first point cloud based on the information of the first point cloud and the information of the second point cloud; and
the second determination module is configured to determine a scale for constructing the target scenario based on the target point cloud and the second point cloud.

According to one or more embodiments of the present disclosure, the first determination module is specifically configured to:
determine a first center coordinate of the first point cloud and a second center coordinate of the second point cloud;
determine a transition matrix between a coordinate system of the target scenario collected by the terminal device and a coordinate system of the target scenario collected by the target device based on a relationship between points in the first point cloud and the first center coordinate, a relationship between points in the second point cloud and the second center coordinate, the first center coordinate and the second center coordinate; and
determine the target point cloud, corresponding to the second point cloud, in the first point cloud based on the transition matrix, the information of the first point cloud and the information of the second point cloud.

According to one or more embodiments of the present disclosure, the first determination module is specifically configured to:
obtain a third point cloud of the second point cloud in the target scenario collected by the terminal device based on the transition matrix; and
determine the target point cloud based on the first point cloud and the third point cloud.

According to one or more embodiments of the present disclosure, the first determination module is specifically configured to:
construct an octree based on the third point cloud; and
determine a point cloud in the first point cloud that is closest to the third point cloud as the target point cloud based on the first point cloud and the octree.

According to one or more embodiments of the present disclosure, the second determination module is specifically configured to:
determine at least one first line segment in the target point cloud;
determine at least one second line segment, corresponding to the first line segment, in the second point cloud;
and determine the scale for constructing the target scenario based on lengths of at least one pair of the first line segment and the second line segment.

According to one or more embodiments of the present disclosure, the second determination module is further configured to:
perform tetrahedralization on the target point cloud to obtain at least one first tetrahedron; and
perform tetrahedralization on a point cloud, corresponding to the target point cloud, in the second point cloud to obtain at least one second tetrahedron;
where the first line segment is an edge of the first tetrahedron and the second line segment is an edge of the second tetrahedron.

According to one or more embodiments of the present disclosure, the second determination module is specifically configured to:
determine a scale error between the target scenario collected by the terminal device and the target scenario collected by the target device based on a difference in the lengths of at least one pair of the first line segment and the second line segment; and
determine the scale at which the terminal device constructs the target scenario based on the scale error.

At least one embodiment of the present disclosure provides a terminal device processing, which includes at least one processor and at least one memory,
where the at least one memory stores computer-executable instructions; and
the at least one processor executes the computer-executable instructions stored in the at least one memory and is caused to execute the method for scenario processing provided by at least one of the above embodiments.

At least one embodiment of the present disclosure provides a non-transitory computer-readable storage medium, which stores computer-executable instructions, where a processor upon executing the computer-executable instructions, implements the method for scenario processing provided by at least one of the above embodiments.

The foregoing are merely descriptions of the preferred embodiments of the present disclosure and the explanations of the technical principles involved. It will be appreciated by those skilled in the art that the scope of the disclosure involved herein is not limited to the technical solutions formed by a specific combination of the technical features described above, and shall cover other technical solutions formed by any combination of the technical features described above or equivalent features thereof without departing from the concept of the present disclosure. For example, the technical features described above may be mutually replaced with the technical features having similar functions disclosed herein (but not limited thereto) to form new technical solutions.

In addition, while operations have been described in a particular order, it shall not be construed as requiring that such operations are performed in the stated specific order or sequence. Under certain circumstances, multitasking and parallel processing may be advantageous. Similarly, while some specific implementation details are included in the above discussions, these shall not be construed as limitations to the present disclosure. Some features described in the context of a separate embodiment may also be combined in a single embodiment. Rather, various features described in the context of a single embodiment may also be implemented separately or in any appropriate sub-combination in a plurality of embodiments.

Although the present subject matter has been described in a language specific to structural features and/or logical method acts, it will be appreciated that the subject matter defined in the appended claims is not necessarily limited to the particular features and acts described above. Rather, the particular features and acts described above are merely exemplary forms for implementing the claims.

1. A method for scenario processing, comprising:
acquiring information of a first point cloud corresponding to a target scenario collected by a terminal device;
acquiring information of a second point cloud corresponding to the target scenario collected by a target device;
determining a target point cloud, corresponding to the second point cloud, in the first point cloud based on the information of the first point cloud and the information of the second point cloud; and
determining a scale for constructing the target scenario based on the target point cloud and the second point cloud.

2. The method according to claim 1, wherein the determining a target point cloud, corresponding to the second point cloud, in the first point cloud based on the information of the first point cloud and the information of the second point cloud, comprises:
determining a first center coordinate of the first point cloud and a second center coordinate of the second point cloud;
determining a transition matrix between a coordinate system of the target scenario collected by the terminal device and a coordinate system of the target scenario collected by the target device based on a relationship between points in the first point cloud and the first center coordinate, a relationship between points in the second point cloud and the second center coordinate, the first center coordinate and the second center coordinate; and
determining the target point cloud, corresponding to the second point cloud, in the first point cloud based on the transition matrix, the information of the first point cloud and the information of the second point cloud.

3. The method according to claim 2, wherein the determining the target point cloud, corresponding to the second point cloud, in the first point cloud based on the transition matrix, the information of the first point cloud and the information of the second point cloud, comprises:
obtaining a third point cloud of the second point cloud in the target scenario collected by the terminal device based on the transition matrix; and
determining the target point cloud based on the first point cloud and the third point cloud.

4. The method according to claim 3, wherein the determining the target point cloud based on the first point cloud and the third point cloud, comprises:
constructing an octree based on the third point cloud; and
determining a point cloud in the first point cloud that is closest to the third point cloud as the target point cloud based on the first point cloud and the octree.

5. The method according to claim 1, wherein the determining a scale for constructing the target scenario based on the target point cloud and the second point cloud, comprises:
determining at least one first line segment in the target point cloud;
determining at least one second line segment, corresponding to the first line segment, in the second point cloud; and
determining the scale for constructing the target scenario based on lengths of at least one pair of the first line segment and the second line segment.

6. The method according to claim 5, further comprising:
performing tetrahedralization on the target point cloud to obtain at least one first tetrahedron; and
performing tetrahedralization on a point cloud, corresponding to the target point cloud, in the second point cloud to obtain at least one second tetrahedron,
wherein the first line segment is an edge of the first tetrahedron and the second line segment is an edge of the second tetrahedron.

7. The method according to claim 5, wherein the determining the scale for constructing the target scenario based on lengths of at least one pair of the first line segment and the second line segment, comprises:
determining a scale error between the target scenario collected by the terminal device and the target scenario collected by the target device based on a difference in the lengths of at least one pair of the first line segment and the second line segment; and
determining the scale at which the terminal device constructs the target scenario based on the scale error.

8. A terminal device, comprising at least one processor and at least one memory,
wherein the at least one memory stores computer-executable instructions; and
the at least one processor executes the computer-executable instructions stored in the at least one memory and is caused to execute a method for scenario processing, and the method comprises:
acquiring information of a first point cloud corresponding to a target scenario collected by a terminal device;
acquiring information of a second point cloud corresponding to the target scenario collected by a target device;
determining a target point cloud, corresponding to the second point cloud, in the first point cloud based on the information of the first point cloud and the information of the second point cloud; and
determining a scale for constructing the target scenario based on the target point cloud and the second point cloud.

9. The terminal device according to claim 8, wherein the determining a target point cloud, corresponding to the second point cloud, in the first point cloud based on the information of the first point cloud and the information of the second point cloud, comprises:
determining a first center coordinate of the first point cloud and a second center coordinate of the second point cloud;
determining a transition matrix between a coordinate system of the target scenario collected by the terminal device and a coordinate system of the target scenario collected by the target device based on a relationship between points in the first point cloud and the first center coordinate, a relationship between points in the second point cloud and the second center coordinate, the first center coordinate and the second center coordinate; and
determining the target point cloud, corresponding to the second point cloud, in the first point cloud based on the transition matrix, the information of the first point cloud and the information of the second point cloud.

10. The terminal device according to claim 9, wherein the determining the target point cloud, corresponding to the second point cloud, in the first point cloud based on the transition matrix, the information of the first point cloud and the information of the second point cloud, comprises:
obtaining a third point cloud of the second point cloud in the target scenario collected by the terminal device based on the transition matrix; and
determining the target point cloud based on the first point cloud and the third point cloud.

11. The terminal device according to claim 10, wherein the determining the target point cloud based on the first point cloud and the third point cloud, comprises:
constructing an octree based on the third point cloud; and
determining a point cloud in the first point cloud that is closest to the third point cloud as the target point cloud based on the first point cloud and the octree.

12. The terminal device according to claim 8, wherein the determining a scale for constructing the target scenario based on the target point cloud and the second point cloud, comprises:
determining at least one first line segment in the target point cloud;
determining at least one second line segment, corresponding to the first line segment, in the second point cloud; and
determining the scale for constructing the target scenario based on lengths of at least one pair of the first line segment and the second line segment.

13. The terminal device according to claim 12, wherein the method further comprises:
performing tetrahedralization on the target point cloud to obtain at least one first tetrahedron; and
performing tetrahedralization on a point cloud, corresponding to the target point cloud, in the second point cloud to obtain at least one second tetrahedron,
wherein the first line segment is an edge of the first tetrahedron and the second line segment is an edge of the second tetrahedron.

14. The terminal device according to claim 12, wherein the determining the scale for constructing the target scenario based on lengths of at least one pair of the first line segment and the second line segment, comprises:
determining a scale error between the target scenario collected by the terminal device and the target scenario collected by the target device based on a difference in the lengths of at least one pair of the first line segment and the second line segment; and
determining the scale at which the terminal device constructs the target scenario based on the scale error.

15. A non-transitory computer-readable storage medium, storing computer-executable instructions, wherein a processor upon executing the computer-executable instructions, implements a method for scenario processing, and the method comprises:
acquiring information of a first point cloud corresponding to a target scenario collected by a terminal device;
acquiring information of a second point cloud corresponding to the target scenario collected by a target device;
determining a target point cloud, corresponding to the second point cloud, in the first point cloud based on the information of the first point cloud and the information of the second point cloud; and
determining a scale for constructing the target scenario based on the target point cloud and the second point cloud.

16. The storage medium according to claim 15, wherein the determining a target point cloud, corresponding to the second point cloud, in the first point cloud based on the information of the first point cloud and the information of the second point cloud, comprises:
determining a first center coordinate of the first point cloud and a second center coordinate of the second point cloud;
determining a transition matrix between a coordinate system of the target scenario collected by the terminal device and a coordinate system of the target scenario collected by the target device based on a relationship between points in the first point cloud and the first center coordinate, a relationship between points in the second point cloud and the second center coordinate, the first center coordinate and the second center coordinate; and
determining the target point cloud, corresponding to the second point cloud, in the first point cloud based on the transition matrix, the information of the first point cloud and the information of the second point cloud.

17. The storage medium according to claim 16, wherein the determining the target point cloud, corresponding to the second point cloud, in the first point cloud based on the transition matrix, the information of the first point cloud and the information of the second point cloud, comprises:
obtaining a third point cloud of the second point cloud in the target scenario collected by the terminal device based on the transition matrix; and
determining the target point cloud based on the first point cloud and the third point cloud.

18. The storage medium according to claim 17, wherein the determining the target point cloud based on the first point cloud and the third point cloud, comprises:
constructing an octree based on the third point cloud; and
determining a point cloud in the first point cloud that is closest to the third point cloud as the target point cloud based on the first point cloud and the octree.

19. The storage medium according to claim 15, wherein the determining a scale for constructing the target scenario based on the target point cloud and the second point cloud, comprises:
determining at least one first line segment in the target point cloud;
determining at least one second line segment, corresponding to the first line segment, in the second point cloud; and
determining the scale for constructing the target scenario based on lengths of at least one pair of the first line segment and the second line segment.

20. The storage medium according to claim 19, wherein the method further comprises:
performing tetrahedralization on the target point cloud to obtain at least one first tetrahedron; and
performing tetrahedralization on a point cloud, corresponding to the target point cloud, in the second point cloud to obtain at least one second tetrahedron,
wherein the first line segment is an edge of the first tetrahedron and the second line segment is an edge of the second tetrahedron.
